(19) United States
(12) Patent Application Publication
(10) Pub. No.: US 2005/0208792 A1
(43) Pub. Date: Sep. 22, 2005

(54) Bending tool for flexible printed circuit assemblies

(75) Inventors: Long V. Nguyen, San Jose, CA (US); Giao T. Duong, Milpitas, CA (US)

Correspondence Address: MICHAEL B. EINSCHLAG, ESQ., 25680 FERNHILL DRIVE, LOS ALTOS HILLS, CA, 94024, US

(73) Assignee: Riospring, Inc., Milpitas, CA (US)

(21) Appl. No.: 11/080,131

(22) Filed: Mar. 15, 2005

Related U.S. Application Data
(60) Provisional application No. 60/555,256, filed on Mar. 22, 2004.

(51) Int. Cl. H01R 12/00

(52) U.S. Cl. 439/74

(57) ABSTRACT

A bending tool for bending a flexible printed circuit assembly including: a base; a first bender, supported by the base, having a first bending tip adapted to bend a first portion of the flexible printed circuit assembly; and a second bender, supported by the base, having a second bending tip adapted to bend a second portion of the flexible printed circuit assembly.

This application claims the benefit of U.S. Provisional Application No. 60/555,256 which was filed on Mar. 22, 2004, and which is incorporated herein by reference.

### TECHNICAL FIELD OF THE INVENTION

One or more embodiments of the present invention relate to manufacturing electronic devices, and more particularly, to bending tools for manufacturing flexible printed circuit assemblies included in electronic devices.

### BACKGROUND OF THE INVENTION

Due to industry trends towards miniaturization of electronic devices, for example and without limitation, data storage devices, internal components of such electronic devices have become smaller and more difficult to manufacture. As a result, manufacturers are inundated with smaller parts and tighter specifications in design, fabrication, and inspection, all of which cause much difficulty in manufacturing of electronic devices.

A Flexible Printed Circuit Assembly (FPCA) included in a small form factor disk drive is an example of a miniature component that is included in an electronic device. Design and fabrication of such an FPCA is complex. In particular, a typical FPCA includes multiple components, such as for example and without limitation, a flex printed circuit and a bracket, and the FPCA may include connectors and stiffeners that are integrated into the flex printed circuit and the bracket, or the FPCA may include further connectors and stiffeners.

In addition to the above, in order to meet manufacturing requirements for miniature components, an FPCA typically has multiple bends, and as such, bending tools are conventionally used to fabricate such bends. Conventionally, fabrication of each bend of the FPCA requires use of a different bending tool. Further, after each bending operation, the FPCA is unloaded from the bending tool, and is loaded onto the next bending tool for the next bending operation, until all necessary bends are made. Although conventional production lines are typically arranged for sequential bending operations, the loading and unloading operations are time-consuming, and they negatively impact productivity.

In light of the above, there is a need in the art for a bending tool that solves one or more of the above-identified problems.

### SUMMARY OF THE INVENTION

One or more embodiments of the present invention solve one or more of the above-identified problems. In particular, one embodiment of the present invention is a bending tool for bending a flexible printed circuit assembly that comprises: a base; a first bender, supported by the base, having a first bending tip adapted to bend a first portion of the flexible printed circuit assembly; and a second bender, supported by the base, having a second bending tip adapted to bend a second portion of the flexible printed circuit assembly.

### BRIEF DESCRIPTION OF THE DRAWING

FIG. 1 shows an exemplary flexible printed circuit assembly (FPCA) that is used in a particular type of 1.8-inch disk drive, the FPCA is shown prior to fabricating bends;

FIG. 2 shows top and bottom perspective views of the FPCA shown in FIG. 1 after it is bent in accordance with a particular exemplary design requirement;

FIG. 3 shows an FPCA bending tool that is fabricated in accordance with one or more embodiments of the present invention which may be used to bend the FPCA shown in FIG. 1 into the form shown in FIG. 2;

FIG. 4 shows an exploded view of the FPCA bending tool shown in FIG. 3;

FIGS. 5A and 5B show how a first bender of the FPCA bending tool shown in FIG. 3 carries out an exemplary bending operation of a portion of the FPCA shown in FIG. 1; and

FIG. 6 shows a cross-sectional view of an exemplary, eccentric, shaft-inside-shaft arrangement of the FPCA bending tool shown in FIG. 3 in accordance with one or more embodiments of the present invention.

### DETAILED DESCRIPTION

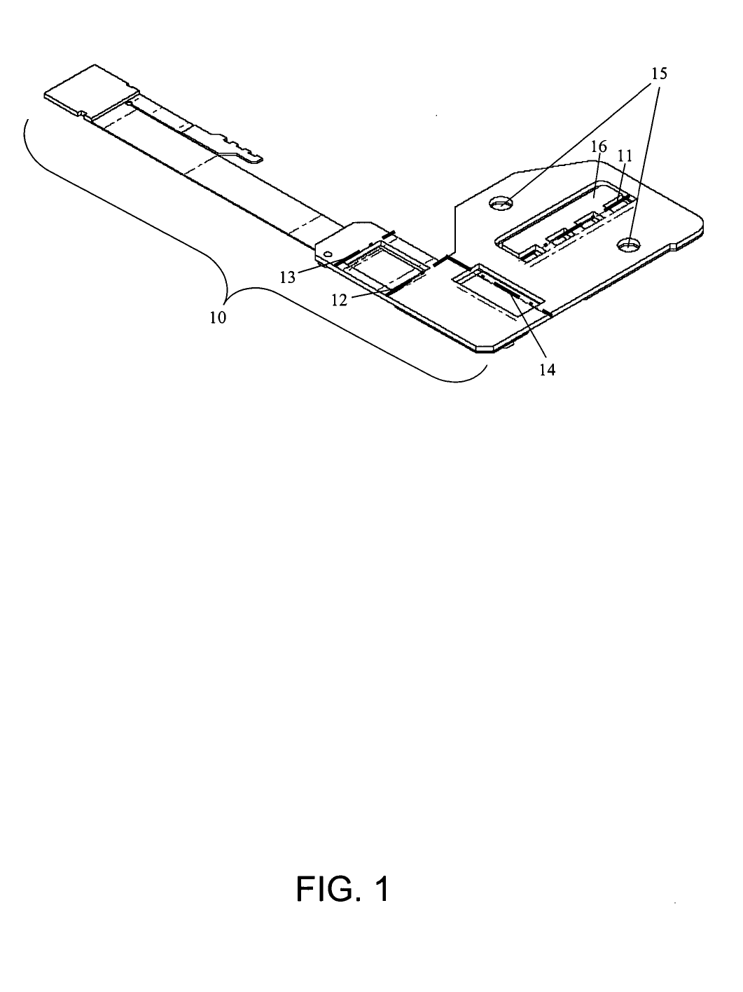

FIG. 1 shows exemplary flexible printed circuit assembly 10 (FPCA 10) that is used in a particular type of 1.8-inch disk drive, FPCA 10 is shown prior to fabricating bends. As shown in FIG. 1, FPCA 10 is designed to be bent in sequence along: (a) first bending line 11; (b) second bending line 12; (c) third bending line 13; and (d) fourth bending line 14. In accordance with one or more embodiments of the present invention, FPCA 10 includes locating holes 15 for use, as will be described in detail below, in positioning FPCA 10 during bending operations.

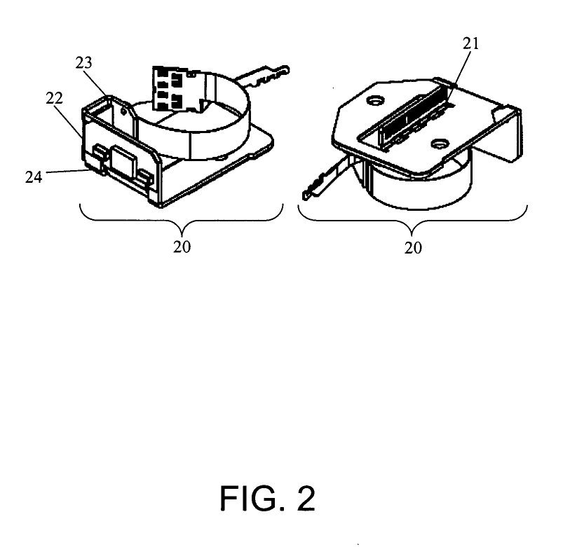

FIG. 2 shows top and bottom perspective views of bent flexible printed circuit assembly 20 (bent FPCA 20) which is produced by bending FPCA 10. Thus, to produce bent FPCA 20, FPCA 10 is bent, in sequence, as follows: first along first bending line 11; next, along second bending line 12; next, along third bending line 13; and finally, along fourth bending line 14 to form first bend 21, second bend 22, third bend 13, and fourth bend 24, respectively, shown in FIG. 2.

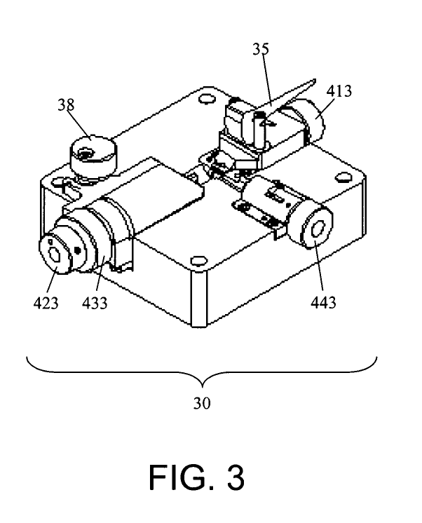

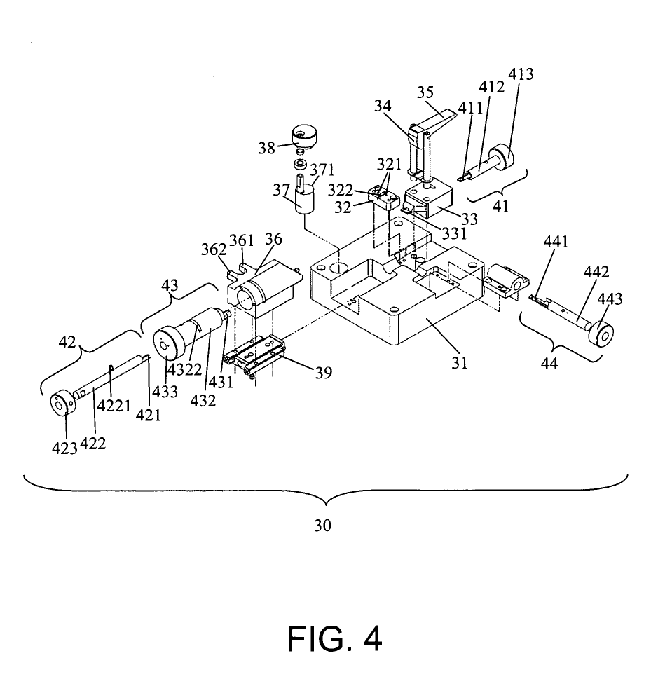

FIG. 3 shows FPCA bending tool 30 that is fabricated in accordance with one or more embodiments of the present invention. As will be described in detail below, FPCA bending tool 30 may be used to bend FPCA 10 shown in FIG. 1 to fabricate bent FPCA 20 shown in FIG. 2. As shown in FIG. 3, and in accordance with one or more embodiments of the present invention, clamp lever 35, bender moving knob 38, first bender knob 413, second bender knob 423, third bender knob 433, and fourth bender knob 443 are adapted to be operated by at least one human or robotic operator in carrying out bending operations that generate first bend 21, second bend 22, third bend 23, and fourth bend 24 shown in FIG. 2. The bending operations are described with reference to an exploded view of FPCA bending tool 30 shown in FIG. 4.

FIG. 4 shows an exploded view of FPCA bending tool 30 shown in FIG. 3. In accordance with one or more embodiments of the present invention, FPCA bending tool 30 includes base 31 that supports first bender 41, second bender 42, third bender 43, and fourth bender 44. As further shown in FIG. 4, first bender 41, second bender 42, third bender 43, and fourth bender 44 comprise, respectively, (a) first bender knob 413, first bender shaft 412, and first bending tip 411; (b) second bender knob 423, second bender shaft 422, and second bending tip 421; (c) third bender knob 433, third bender shaft 432, and third bending tip 431; and (d) fourth bender knob 443, fourth bender shaft 442, and fourth bending tip 441. In accordance with one or more embodiments of the present invention, first bender knob 413, second bender knob 423, third bender knob 433, and fourth bender knob 443 may each be utilized by at least one human or robotic operator to apply a torque. In accordance with one or more embodiments of the present invention, such torques are transmitted by first bender shaft 412, second bender shaft 422, third bender shaft 432, and fourth bender shaft 442, respectively, to rotate first bending tip 411, second bending tip 421, third bending tip 431, and fourth bending tip 441, respectively. In accordance with one or more such embodiments, first bending tip 411, second bending tip 421, third bending tip 431, and fourth bending tip 441 are disposed to contact and exert a torque on appropriate portions of FPCA 10 (the appropriate portions are designated in accordance with predetermined design requirements) to generate first bend 21, second bend 22, third bend 23, and fourth bend 24, respectively, whenever these bending tips are rotated by torques applied to bending knobs 413, 423, 433, and 443, respectively. In accordance with one or more embodiments of the present invention, base 31 is made of aluminum. Further, in accordance with one or more embodiments of the present invention, first bender 41, second bender 42, third bender 43, fourth bender 44, first bending tip 411, second bending tip 421, third bending tip 431, and fourth bending tip 441 are made of steel, for example and without limitation, stainless steel or heat treated tool steel. As well known to one of ordinary skills in the art, all the above components of FPCA bender 30 can readily be made by a machine shop.

As further shown in FIG. 4, in accordance with one or more embodiments of the present invention, FPCA bending tool 30 further includes: (a) FPCA nest 32 which carries FPCA 10 in a manner to be described in detail below; (b) clamping unit 33 which secures FPCA 10 in position for bending operations in a manner to be described in detail below; and (c) a bender moving mechanism that includes bender carrier 36, driving cam 37, and bender moving knob 38.

In accordance with one or more embodiments of the present invention, and as shown in FIG. 4, FPCA nest 32 includes locating pins 321 that are designed to match locating holes 15 shown in FIG. 1; locating pins 321 enable precise positioning of FPCA 10 when FPCA 10 is placed on FPCA nest 32 during bending operations.

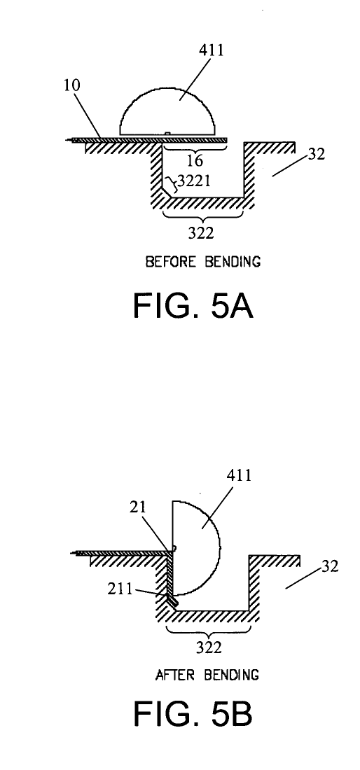

FIGS. 5A and 5B show how first bender 41 of FPCA bending tool 30 carries out a first bending operation of portion 16 of FPCA 10 shown in FIG. 1. To perform the bending operation, FPCA 10 is placed on FPCA nest 32. As shown in FIG. 4 and in expanded scale in FIG. 5A, in accordance with one or more embodiments of the present invention, FPCA nest 32 includes pocket structure 322. As further shown in FIG. 5A, portion 16 of FPCA 10 extends over an edge of pocket structure 322, and first bending tip 411 is disposed over FPCA 10 and an edge of pocket structure 322. Thus, as first bending tip 411 rotates, it rotates about the edge and applies a torque to portion 16. Further, note that pocket structure 322 provides space for movement of first bending tip 411 and first portion 16 of FPCA 10 that is free from support by FPCA nest 32. As one can readily appreciate from FIGS. 5A and 5B, in accordance with one or more embodiments of the present invention, first bend 21 (shown in FIG. 2) is formed by rotating first bending tip 411 clockwise (in FIGS. 5A and 5B) to bend portion 16 inside pocket structure 322 until portion 16 contacts and is stopped by a wall of pocket structure 322 in FPCA nest 32. As further shown in FIGS. 5A and 5B, in accordance with one or more further embodiments of the present invention, pocket structure 322 further comprises mold feature 3221 along the bottom of the wall. As one can readily appreciate, mold feature 3221 is adapted to shape first portion 16 in conjunction with first bending tip 411 to form, for example and without limitation, V-bend 211 in accordance with a particular design requirement for bent FPCA 20.

Referring again to FIG. 4, in accordance with one or more embodiments of the present invention, clamping unit 33 is a cam-follower that moves vertically following rotation of clamp cam 34, wherein rotation of clamp cam 34 is driven by clamp lever 35. In accordance with one or more embodiments the present invention, clamping unit 33 comprises clamping tip 331 that is adapted to contact FPCA 10 and exert force on FPCA 10. As a result, whenever clamp lever 35 is pushed downwards, clamp cam 34 presses clamping unit 33 down so that clamping tip 331 presses against FPCA 10 to secure FPCA 10 in place on FPCA nest 32. A compression spring (not shown, and made of, for example and without limitation, beryllium copper) is disposed underneath clamping unit 33, so that, whenever clamp lever 35 is lifted upwards to remove pressure from clamp cam 34, clamping unit 33 will be lifted up to provide a gap between clamping tip 331 and FPCA 10—the gap enables loading of FPCA 10 and unloading of bent FPCA 20. In accordance with one or more embodiments of the present invention, clamping unit 33 (including clamping tip 331) and clamp cam 34 are made of steel.

As further shown in FIG. 4, in accordance with one or more embodiments of the present invention, FPCA bending tool 30 also includes a bender moving mechanism that includes: (a) bender carrier 36; (b) driving cam 37 that is disposed between advance engaging element 361 and retract engaging element 362 of bender carrier 36; and (c) bender moving knob 38. The bender moving mechanism: (a) advances second bender 42 and third bender 43 towards FPCA 10 to effectuate bending operations that generate second bend 22 and third bend 23; and (b) retracts second bender 42 and third bender 43 after the bending operations that generate second bend 22 and third bend 23 operations have been completed. When bender moving knob 38 is turned in a direction, for example, a clockwise direction, driving cam 37 advances bender carrier 36 (and hence second bender 42 and third bender 43) towards FPCA 10 by pushing against advance engaging element 361 with maximum radius edge 371. This places second bender 42 and third bender 43 in position to perform bending operations that provide second bend 22 and third bend 23 (by rotating second bender knob 423 and third bender knob 433, respectively). After these bending operations are completed, bender moving knob 38 is turned in another direction, for example, a counter-clockwise direction, and driving cam 37 retracts bender carrier 36 (and hence, second bender 42 and third bender 43) by pushing against retract engaging element 362 with maximum radius edge 371. As one can readily appreciate, in accordance with one or more embodiments of the present invention, the travel distance of bender carrier 36 is two times the maximum radius of driving cam 37.

In accordance with one or more embodiments of the present invention, bender carrier 36 and driving cam 37 are made of steel. Further, in accordance with one or more further embodiments of the present invention, bender carrier 36 is carried by slider 39 that comprises ball bearings to minimize friction between it and base 31 and to provide smooth linear movement of bender carrier 36. Further, in accordance with one or more alternative embodiments of the present invention, a handle can be installed in place of driving cam 37 for use by an operator in moving bender carrier 36.

As shown in FIGS. 3 and 4, in accordance with one or more embodiments of the present invention, to assemble FPCA bending tool 30, second bender shaft 422 is inserted through third bender knob 433 and third bender shaft 432 so that (a) second bender knob 423 is exposed at one end of third bender 43 for use by the operator; and (b) second bending tip 421 is exposed at another end of third bender 43 to enable it to bend FPCA 10 to provide second bend 22. Accordingly, as one can readily appreciate, second bender 42 is carried by third bender 43, which third bender 43 is carried, in turn, by bender carrier 36. This bender-inside-bender arrangement takes advantage of a particular design of bent FPCA 20 wherein second bend 22 and third bend 23 are positioned close to each other.

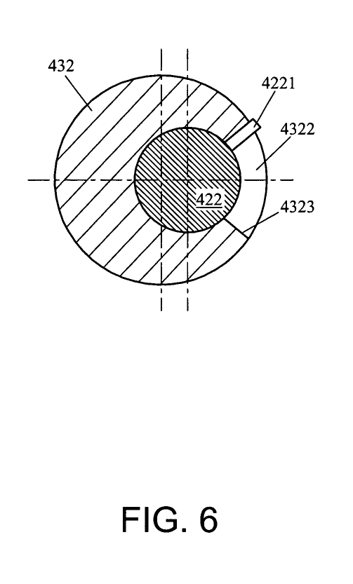

FIG. 6 shows a cross-sectional view of an exemplary, eccentric, shaft-inside-shaft arrangement of the bender-inside-bender arrangement of second bender 42 and third bender 43 discussed above. As shown in FIG. 6, in accordance with one or more embodiments of the present invention, second bender shaft 422 is eccentrically disposed inside third bender shaft 432 to enable second bender 42 and third bender 43 to provide bends that conform to a particular design of bent FPCA 20. Further, as shown in FIG. 4 and FIG. 6, in accordance with one or more embodiments of the present invention, second bender 42 includes driving pin 4221 that is affixed to second bender shaft 422, and third bender shaft 432 includes driving pin path 4322. In accordance with one or more such embodiments, in assembling FCPA bending tool 30, driving pin 4221 is affixed to second bender shaft 422 through driving pin path 4322 after second bender shaft 422 has been inserted through third bender shaft 432. As one can readily appreciate from FIG. 6, when second bender shaft 422 rotates in a clockwise direction, driving pin 4221 rotates in the clockwise direction, along driving pin path 4322, and once driving pin 4221 contacts engaging wall 4323 at the end of driving pin path 4322, subsequent rotation of second bender shaft 422 also drives rotation of third bender shaft 432 (and hence third bending tip 431). As a result, second bend 22 and third bend 23 are produced at the same time.

As shown in FIGS. 3 and 4, in accordance with one or more embodiments of the present invention, second bender shaft 422 slip-fits a bored cavity of third bender shaft 432, and third bender shaft 432 slip-fits a bored cavity of bender carrier 36. The cavities limit and guide rotations of second bender shaft 422 and third bender shaft 432, respectively. In addition, angle ranges of the rotations, which correspond to angles of bends, can be limited by one or more mechanisms that are well know to one of ordinary skills in the art such as, for example and without limitation, pins and stoppers. In accordance with one or more embodiments of the present invention, lubricant is applied in the cavities to reduce wear of the shafts and bender carrier 36.

Advantageously, a flexible printed circuit assembly bending tool fabricated in accordance with one or more embodiments of the present invention may reduce loading and unloading time in fabrication of flexible printed circuit assemblies, and therefore simplify operations and improve productivity of electronic device manufacturing. It also may save manufacturing facility space and maintenance cost.

The embodiments of the present invention described above are exemplary. Many changes and modifications may be made to the disclosure recited above, while remaining within the scope of the invention. The scope of the invention should, therefore, be determined not with reference to the above description, but instead should be determined with reference to the appended claims along with their full scope of equivalents.

1. A bending tool for bending a flexible printed circuit assembly comprising:
a base;
a first bender, supported by the base, having a first bending tip adapted to bend a first portion of the flexible printed circuit assembly; and
a second bender, supported by the base, having a second bending tip adapted to bend a second portion of the flexible printed circuit assembly.

2. The bending tool of claim 1 further comprising a third bender, supported by the base, having a third bending tip adapted to bend a third portion of the flexible printed circuit assembly.

3. The bending tool of claim 2 further comprising a fourth bender, supported by the base, having a fourth bending tip adapted to bend a fourth portion of the flexible printed circuit assembly.

4. The bending tool of claim 1 wherein at least a portion of the second bender is inside the first bender.

5. The bending tool of claim 4 wherein a substantial portion of the second bender is inside the first bender.

6. The bending tool of claim 4 wherein movement of the second bender causes movement of the first bender.

7. The bending tool of claim 1 wherein the first bender further comprises a first shaft connected to the first bending tip, which first shaft is adapted to transmit torque exerted on the first shaft to the first bending tip.

8. The bending tool of claim 7 wherein the second bender further comprises a second shaft connected to the second bending tip, which second shaft is adapted to transmit torque exerted on the second shaft to the second bending tip.

9. The bending tool of claim 8 wherein at least a portion of the second shaft is inside the first bender.

10. The bending tool of claim 9 wherein a substantial portion of the second shaft is inside the first bender.

11. The bending tool of claim 9 wherein rotation of the first shaft and rotation of the second shaft are eccentric.

12. The bending tool of claim 9 wherein the first shaft and the second shaft are disposed so that rotation of the second shaft causes rotation of the first shaft.

13. The bending tool of claim 9 wherein the second shaft comprises a pin that is adapted to drive rotation of the first shaft.

14. The bending tool of claim 1 further comprising a bender moving mechanism adapted to move the first bender towards and away from the flexible printed circuit assembly.

15. The bending tool of claim 14 wherein the bender moving mechanism comprises a bender carrier which carries the first bender and a driving cam, which driving cam is adapted to drive movement of the bender carrier.

16. The bending tool of claim 1 further comprising a pocket structure disposed so that a portion of the flexible printed circuit assembly may be bent by rotation of the first bending tip, and thereby the portion, about an edge of the pocket structure.

17. The bending tool of claim 1 further comprising a flexible printed circuit assembly nest adapted to carry the flexible printed circuit assembly.

18. The bending tool of claim 17 wherein the flexible printed circuit assembly nest comprises one or more locating pins adapted to position the flexible printed circuit assembly.

19. The bending tool of claim 17 wherein the flexible printed circuit assembly nest comprises a pocket structure disposed so that a portion of the flexible printed circuit assembly may be bent by rotation of the first bending tip, and thereby the portion, about an edge of the pocket structure.

20. The bending tool of claim 17 wherein the pocket structure includes a space to enable movement of the first bending tip and the portion.

21. The bending tool of claim 1 further comprising a clamp adapted to secure the flexible printed circuit assembly.

22. The bending tool of claim 21 wherein the clamp comprises a clamping unit and a clamp cam adapted to drive movement of the clamping unit.

23. The bending tool of claim 1 further comprising a mold feature adapted to resist the first portion that is bent by the first bending tip to form the first portion into a shape in accordance with design of the flexible printed circuit assembly.
